(19) United States
(12) Patent Application Publication
(10) Pub. No.: US 2015/0242841 A1
(43) Pub. Date: Aug. 27, 2015

(54) Electronic Device and Payment Method Using Electronic Device

(71) Applicant: KR PARTNERS CO., LTD., Seoul (KR)

(72) Inventors: Ho Young Kim, Seoul (KR); Ki Seok Nan, Seoul (KR)

(21) Appl. No.: 14/423,023

(22) PCT Filed: Sep. 20, 2012
(86) PCT No.: PCT/KR2012/007510

§ 371 Date: Feb. 20, 2015

(30) Foreign Application Priority Data
Aug. 24, 2012 (KR) 10-2012-0092822

(51) Int. Cl. G06Q 20/32; G06Q 20/40

(52) U.S. Cl. CPC G06Q 20/3226; G06Q 20/405; G06Q 20/401; G06Q 20/3255

(57) ABSTRACT

Disclosed is an electronic device which may distribute a payment information to a plurality of protocol layers defined by a specific communication protocol and transmit to a payment system. Therefore, a payment with a higher security level may be performed by an electronic device of the present invention.

### TECHNICAL FIELD

The present invention relates to a payment technology, and in particular to a payment technology wherein a distribution transmission is available through a plurality of protocol layers defined based on a specific communication protocol.

### BACKGROUND ART

In case where data are transmitted through a single network in an electronic device, in particular, when transmitting a data such as a card payment information, etc., a security issue may be considered as an important matter.

In order to resolve such a security issue, a method for distributing and transmitting data through a plurality of heterogeneous networks has been widely used.

However, in this case, two or more than two communication networks are necessary, for which it urgently needs to develop a new data transmission method providing an enhanced security while using one communication network.

### DISCLOSURE OF INVENTION

Accordingly, it is an object of the present invention to provide an electronic device and a payment method using the electronic device which make it possible to carry out a security-enhanced payment while using one communication network.

The technical problems to be resolved in the present invention are not limited by the above-mentioned technical issues. Another technical problem not mentioned in the above may be understood clearly by a person having ordinary skill in the art to which the present invention pertains.

In order to achieve the above objects, there is provided an electronic device which may include a communication unit which is configured to perform a communication function with a payment system based on a specific communication protocol; and a control unit which is configured to distribute the payment information to a plurality of protocol layers defined by the specific communication protocol and transmit to the payment system.

In order to achieve the above objects, there is provided a payment method using the electronic device may include forming a network for a communication with a payment system based on a specific communication protocol; and distributing a payment information to a plurality of protocol layers define by the specific communication protocol and transmitting to the payment system.

The payment method using the electronic device according to an exemplary embodiment of the present invention may be implemented by executing a computer program made to implement the mobile terminal driving method stored in a computer readable recording medium.

According to the electronic device and the payment method using the electronic device, since the payment information is distributed and transmitted through a plurality of heterogeneous protocol layers, the payment with enhanced security may be performed.

### BRIEF DESCRIPTION OF DRAWINGS

FIG. 1 is a view illustrating a configuration of a payment environment according to the present invention;

FIG. 2 is a block diagram illustrating an electronic device according to the present invention.

FIG. 3 is a flow chart illustrating an example of a payment method using an electronic device according to the present invention.

FIG. 4 is a view illustrating an example wherein a payment information is distributed and transmitted through a pair of protocol layers defined in the same communication network in a mobile terminal according to the present invention based on the payment method in FIG. 3;

FIG. 5 is a flow chart illustrating an example of a payment method using an electronic device according to the present invention;

FIG. 6 is a flow chart illustrating an example of a payment method using an electronic device according to the present invention;

FIG. 7 is a view illustrating a protocol layer of a mobile communication protocol using an electronic device according to the present invention;

FIG. 8 is a view illustrating the SMS protocol layer in FIG. 7;

FIG. 9 is a view illustrating a message structure of the SMS protocol layer in FIG. 7; and

FIG. 10 is a flow chart illustrating an example of a payment method using an electronic device according to the present invention.

### DETAILED DESCRIPTION

It is advised that the accompanying drawings illustrating the exemplary embodiments of the present invention and the contents illustrated in the accompanying drawings should be referenced so as to fully understand the advantages in operations and objects achieved by the exemplary embodiments of the present invention.

Throughout the present specification, that any component ‘transmits or transfers’ a data or a signal to another component should be interpreted to mean that the data or signal may be directly transmitted or transferred to another component, and the data or signal may be transmitted to another component through at least one or other components. In addition, the suffix ‘module’ or ‘unit’ for the components used in the detailed descriptions may be given or combined given the easiness of the preparation of the specification, and such terms should not be understood to mean a specific meaning or role which may distinguish them from others.

The above described objects, features and advantages of the present invention may become clear through the accompanying drawings and the detailed descriptions below. The exemplary embodiments of the present invention will be described with reference to the accompanying drawings. Throughout the specification, the same reference numbers represent the same components. In addition, in case where it is understood that the detailed descriptions of the known functions or configuration related to the present invention are considered as making unclear the subject matters of the present invention, such detailed descriptions may be omitted.

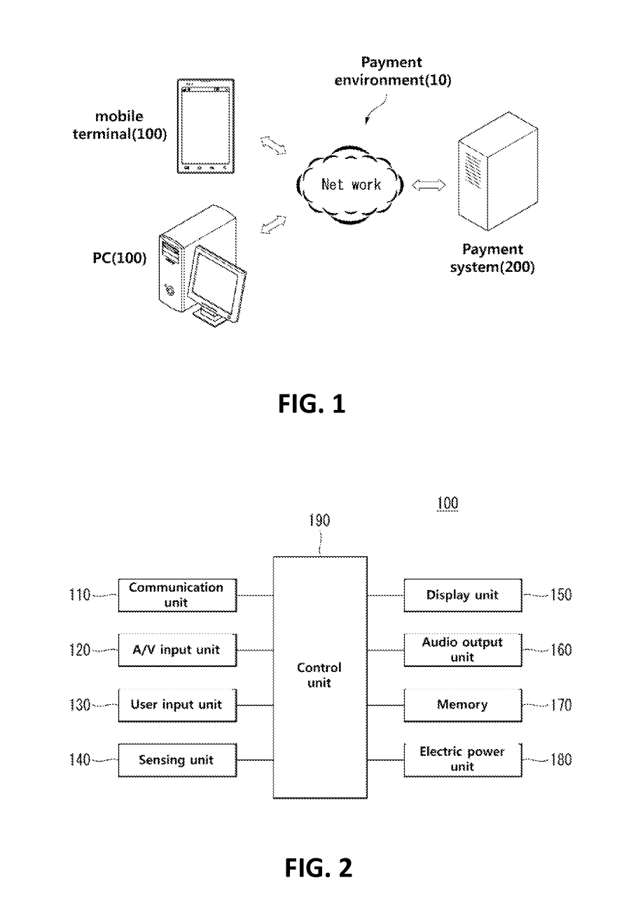

FIG. 1 is a view illustrating a configuration of a payment environment 10 according to the present invention. Referring to FIG. 1, the payment environment 10 may include an electronic device 100 and a payment system 200 which are connected through a network. As illustrated in FIG. 1, the electronic device used in the present invention may be a mobile phone such as a smart phone as well as a fixed type device such as a personal computer. However, the application range of such devices is not limited there to. In addition, the electronic device 100 may be a payment terminal at a franchise.

The electronic device 100 may perform a communication for payment with the payment system 200 based on a specific communication protocol. At this time, the electronic device 100 may be configured to distribute the payment information to a plurality of protocol layers defined by a specific protocol and transmit to the payment system 200. The payment information transmitted to the payment system 200 may include a payment product, the price of the payment product, a credit card information, a password, a user's resident identification number, etc. In the present invention, the applicable range of such information is not limited thereto.

As illustrated in FIG. 1, the payment system 200 is implemented in one device for the sake of convenient descriptions. However, the payment system 200 may include at least one among a financial corporation's server, a credit card corporation's server, a VAN corporation's server, and a product sale site's server. However, the device which may pertain to the payment system 200 in the payment environment 10 according to the present invention is not limited to the above examples.

Since the electronic device 100 transmits a payment information through a plurality of heterogeneous protocol layers defined in one communication network, the electronic device 100 may acquire a security-enhanced payment as compared with the conventional payment method in which a payment information is transmitted through one protocol layer.

FIG. 2 is a block diagram illustrating an electronic device 100 according to the present invention. Referring to FIG. 2, the electronic device 100 may include a communication unit 110, an A/V input unit 120, a user input unit 130, a sensing unit 140, a display unit 150, an audio output unit 160, a memory 170, an electric power unit 180, and a control unit 190. The components illustrated in FIG. 2 are not necessary components. The electronic device 100 may include more components or less components as compared with the above listed components. Each of the above-listed components will be described below.

The communication unit 110 may include one or more than one module which may provide a wired/wireless communication between the electronic unit 100 and the communication network. For example, the communication unit 110 may include a broadcast receiving module, a mobile communication module, a wireless internet module, a local area communication module, etc. The communication unit 110 may receive a broadcast signal through the communication network. The communication unit 110 may perform a communication function with the payment system 200 based on a specific communication protocol.

The A/V (Audio/Video) input unit 120 is configured to input an audio signal or a video signal and may include a camera, a microphone, etc. The camera may process a video frame such as a still image or a motion image obtained by an image sensor in the video communication mode or in the photographing mode. The microphone receives an external audio signal and processes into an electric audio data.

The user input unit 130 is configured for a user to generate an input data for the sake of an operation control of the electronic device 100. For example the user input unit 130 may be used for the user to generate a payment information. The user input unit 130 may be formed of a key pad, a dome switch, a touch pad (constant pressure type/electrostatic type), a jog wheel, a jog switch, etc.

The sensing unit 140 may detect the current state of the electronic device 100 or may detect the state of the user and may detect the surrounding environment state of the electronic device 100. The data sensed by the sensing unit 140 may be used as a basic data for controlling the operation of the electronic device 100.

The display unit 150 outputs the information processed by the electronic device 100. For example, the display unit 151 may display the information related to the payment performed by the electronic device 100. The display unit 150 may include a liquid crystal display, a thin film transistor-liquid crystal display, an organic light-emitting diode, and a flexible display.

The audio output unit 160 outputs an audio signal related to the functions performed by the electronic device 100. The audio output unit 160 may include a receiver, a speaker, a buzzer and the like. In addition, the audio output unit 160 may be configured to output audio through an earphone jack.

The memory 170 may be configured to store the program for the operation of the control unit 190 and may temporarily or permanently store the data which are inputted and outputted. The memory 170 may be configured to temporarily or permanently store the video data outputted through the display unit 150 and the audio data corresponding to the video data. For example, the memory 170 may temporarily or permanently store the payment-related information.

The memory 170 may include a storage medium of any type of a flash memory type, a hard disk type, a multimedia card micro type, a card type memory (for example, SD memory or XD memory, etc.), a random access memory, a static random access memory, a read-only memory, an EEPROM (Electrically Erasable Programmable Read-Only Memory), a PROM (Programmable Read-Only Memory), a magnetic memory, a magnetic disk, and an optical disk type. The electronic device 100 may be configured to operate in sync with a web storage which has a storing function of the memory 170 on the internet.

The control unit 190 in general is configured to control the whole operations of the electronic device 100. The control unit 190 may control for the payment information to be distributed to a plurality of protocol layers defined by a specific communication protocol which is used for a communication with the payment system 200 and may transmit the payment information to the payment system 200.

The electric power 180 unit may be configured to receive an external electric power and an internal electric power in response to a control of the control unit 190 and supply electric power which is necessary for the operation of each component. The electric power unit 180 may be configured to receive an internal electric power or an external electric power in response to a control of the control unit 190 which is necessary for the operation of each component.

The various embodiments disclosed herein may be implemented by a computer-readable or similar device-readable recording medium using a software, a hardware or a combination thereof.

According to the hardware-based implementation, the present embodiment may be implemented using any of ASICs (application specific integrated circuits), DSPs (digital signal processors), DSPDs (digital signal processing devices), PLDs (programmable logic devices), FPGAs (field programmable gate arrays, processors, controllers, micro-controllers, microprocessors, and an electric unit for performing functions. It is obvious that part of such embodiments may be implemented by the control unit 190.

According to the software-based implementation, the embodiments related to procedures or functions may be implemented together with a separate software module which is configured to perform at least one function or operation. The software code may be implemented by a software application made using a proper program language. In addition, the software code may be stored in the memory 170 and may be executed by the control unit 190.

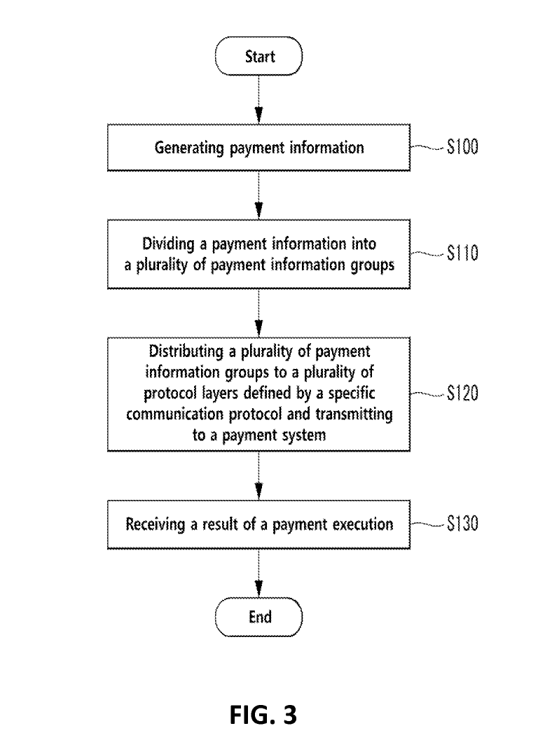

FIG. 3 is a flow chart illustrating an example of the payment method using the electronic device 100 according to the present invention. Herein under, the payment method will be described with the accompanying drawings.

In a state where the network for a communication with the payment system 200 is made based on a specific communication protocol, a payment information is generated at the electronic device 100 (S100).

Thereafter, the control unit 190 of the electronic device 100 divides the generated payment information into a plurality of payment information groups (S110). For example, the control unit 190 may divide the payment information into a plurality of groups based on the previously set levels of the security. Describing using the credit card as an example, the security level of the information such as payment information such as a credit card number, a password, etc. may be higher than the security level of the payment information such as a payment product, a payment amount, etc.

Next, the control unit 190 distributes a plurality of the payment information groups to a plurality of the protocol layers based on the specific protocol and transmits to the payment system 200 (S120). For example, the control unit 190 may transmit the payment information group with a higher security level through the protocol layer with a high security level among a plurality of the protocol layers to the payment system 200 and may transmit the payment information with a lower security level through the protocol layer with a lower security level among a plurality of the layers to the payment system 200.

Thereafter, the electronic device 100 receives a result of the payment operation from the payment system 200 (S130) and may display a result of the received payment operation on the display unit 150. So, the user may confirm a result of the payment operation on the display unit 150.

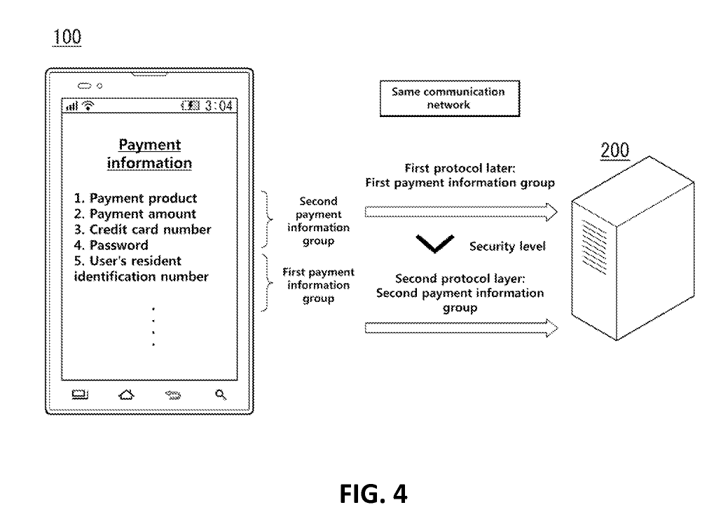

FIG. 4 is a view illustrating an example wherein the mobile terminal 10 distributes the payment information through two protocol layers defined by the same communication network and transmits the payment information.

First, the control unit 190 of the mobile terminal 100 classifies the payment information generated at the mobile terminal 100 into a first payment information group and a second payment information group based on the security levels. Here, the security level of the first payment information group may be higher than the security level of the second payment information group.

The control unit 190 transmits the first payment information group the security level of which is higher, through the first protocol layer defined by the same communication network to the payment system 200, and transmits the second payment information group the security level of which is lower, through the second protocol layer defined by the same communication network to the payment system 200.

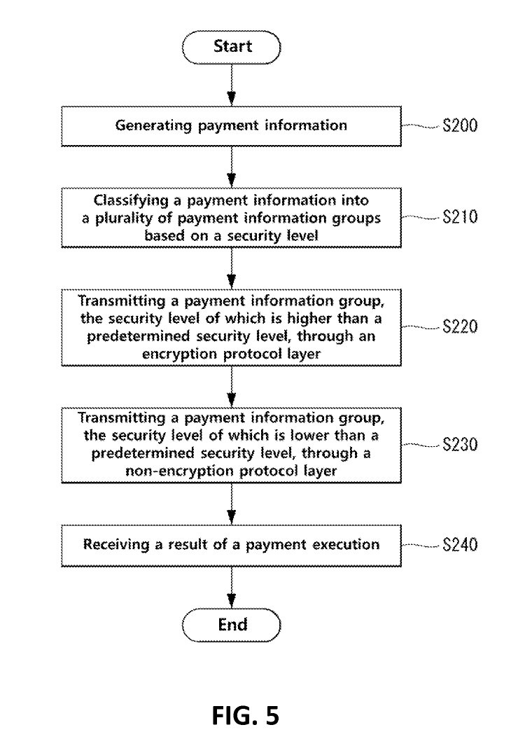

FIG. 5 is a flow chart illustrating an example of the payment method using the electronic device 100 according to the present invention. The payment method will be described with reference to the accompanying drawings.

In a state where the network for a communication with the payment system 200 based on a specific communication protocol, a payment information is generated at the electronic device (S200). The control unit 190 of the electronic device 100 classifies the generated payment information into a plurality of payment information groups (S210). For example, the control unit 190 may divide the payment information into a plurality of groups based on the previously set security levels.

Next, the control unit 190 transmits the payment information group, the security level of which is higher than a predetermined level, among a plurality of the payment information groups through an encryption protocol layer among a plurality of the protocol layers defined by the specific protocol to the payment system 200 (S220). Here, the encryption protocol layer means a protocol layer which is allocated to transmit and receive the data encrypted at the specific communication protocol.

Next, the control unit 190 transmits the payment information group, the security level of which is lower than a predetermined level, among a plurality of the payment information groups, through a non-encrypted protocol layer among a plurality of the protocol layers defined by the specific protocol to the payment system 200 (S230).

Thereafter, the electronic device 100 receives a result of the payment execution from the payment system 200 and may display a result of the received payment execution on the display unit 150.

According to the payment method, since the payment information is distributed to a plurality of the protocol layers and is transmitted and at the same time part of the payment information, the security level of which is higher, is encrypted and transmitted, so a higher security level may be secured.

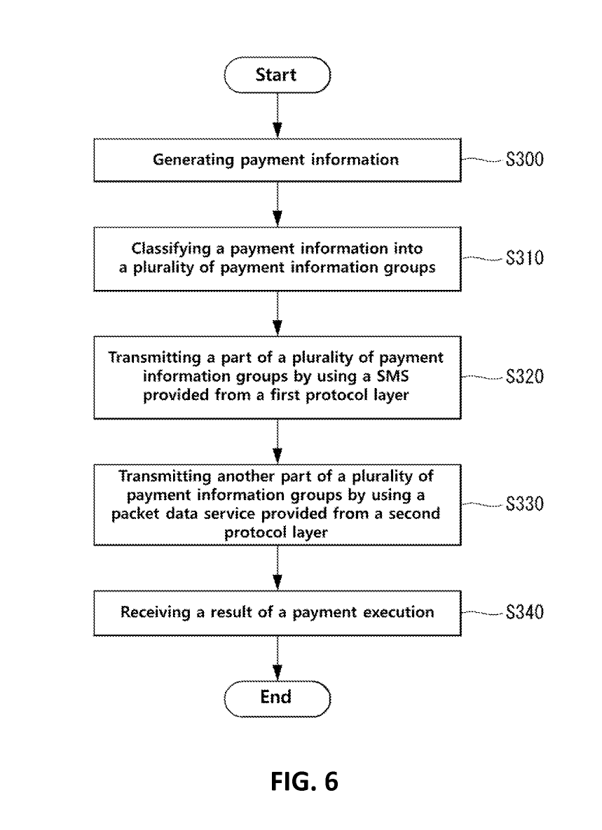

FIG. 6 is a flow chart illustrating an example of the payment method using the electronic device 100 according to the present invention. The payment method will be described with reference to the accompanying drawings.

In a state where the network for a communication with the payment system 200 is formed based on a specific mobile communication protocol, a payment information is generated at the electronic device 100 (S300). The control unit 190 of the electronic device 100 divides the generated payment information into a plurality of payment information groups (S310). As mentioned above, the control unit 190 may divide the payment information into a plurality of payment information groups based on the previously set security levels.

Next, the control unit 190 transmits a part of a plurality of the payment information groups to the payment system 200 by using a short message service (SMS) provided from the first protocol layer (S320). Another part of a plurality of the payment information group may be transmitted using a packet data service provided from the second protocol layer (S330). Here, the security level of a part of the payment information groups may higher than the security level of another part of the payment information groups. In addition, the security level of the short message service may be higher than the security level of the packet data service.

Next, the electronic device 100 receives a result of the payment execution from the payment system 200 (S340) and may display a result of the received payment execution on the display unit 150. The user may see the display unit 150, thus confirming a result of the payment execution.

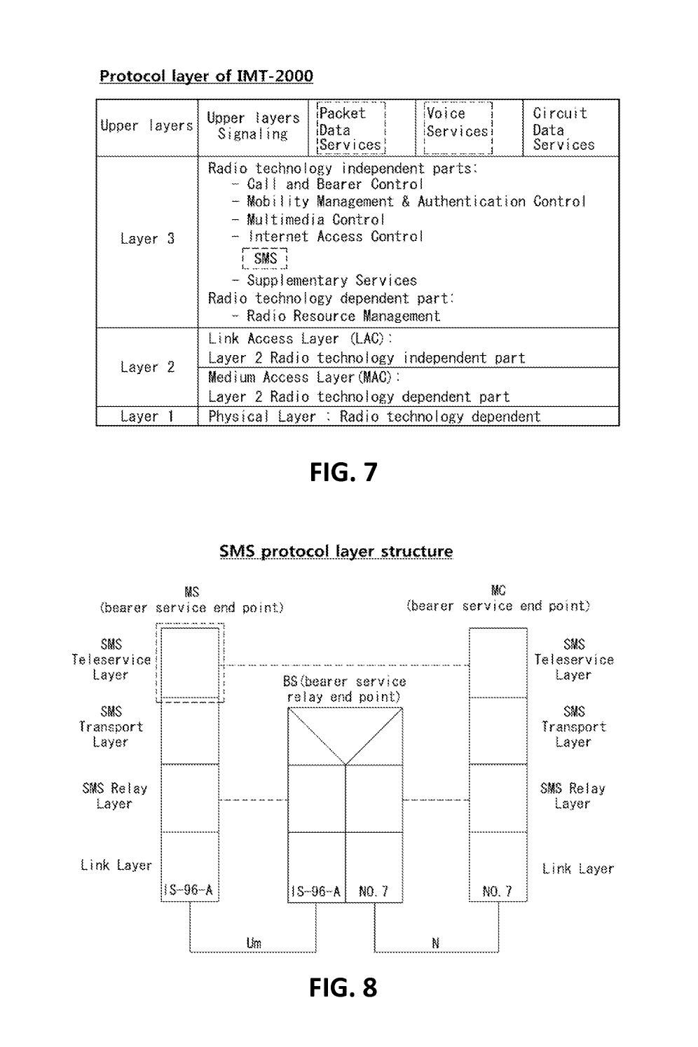

FIG. 7 is a view illustrating a protocol layer of a mobile communication protocol using an electronic device 100 according to the present invention. More specifically, the protocol layer represents a protocol layer of the IMT-2000 (International Mobile Telecommunication-2000) which is a kind of the 3rd generation mobile communication.

The protocol of the wireless section defined by the IMT-2000 includes a physical layer and three layers. The electronic device 100 according to the present invention may transmit a part of the payment information to the payment system 200 by using the short message service supported by the specific protocol layer (layer-3), and may transmit another part of the payment information to the payment system 200 by using the packet data service provided by another protocol layer.

In addition, the control unit 190 may transmit another part of the payment information to the payment system 200 by using a voice service provided by another protocol layer.

The security level of the specific protocol layer may be higher than the security level of another protocol layer. The electronic device 100 according to the present invention may transmits the information, the security level of which is higher than a predetermined security level, among the payment information through the specific layer and may transmit the payment information, the security level of which is relatively lower, through another protocol layer.

FIG. 8 is a view illustrating the SMS protocol layer in FIG. 7. The SMS protocol layer may include a link layer, a relay layer, a transport layer and a tele-service layer. The SMS is formed based on the link layer and has the length of the message which would not exceed 200 bytes corresponding to 100 Korean letters. The payment information may be transmitted through the tele-service layer to the payment system 200.

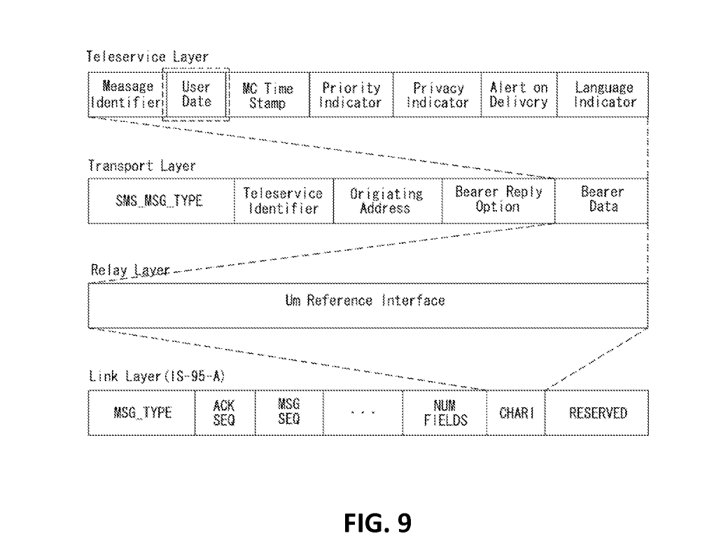

FIG. 9 is a view illustrating a message structure of the SMS protocol layer in FIG. 7.

A specific message ‘CHART’ of the link layer may include a SMS parameter in a capsulated form, and the link layer analyzes the SMS parameter and transmits it to a higher link.

A transport layer is formed through an interface ‘UM Interface’ of the relay layer based on the link layer. The transport layer message may include a tele-service identifier which is a service identifier such as a voice-office box or a common message, a transmitter's telephone (Originating Address), a response request state (Bearer Relay Option), and a bearer data.

The bearer data forms a tele-service layer, and the tele-service layer provides an application service. The tele-service layer may include a user data containing the content of a receiving message, a time (MC Time Stamp) of a message center with respect to a corresponding message, a priority indicator, a secret state indicator (Privacy Indicator), a message arrival alarm message (Alert on Delivery), and a language identification indicator (Language Indicator).

The payment information may be included in a user data region of the tele-service layer and may be transmitted to the payment system 200.

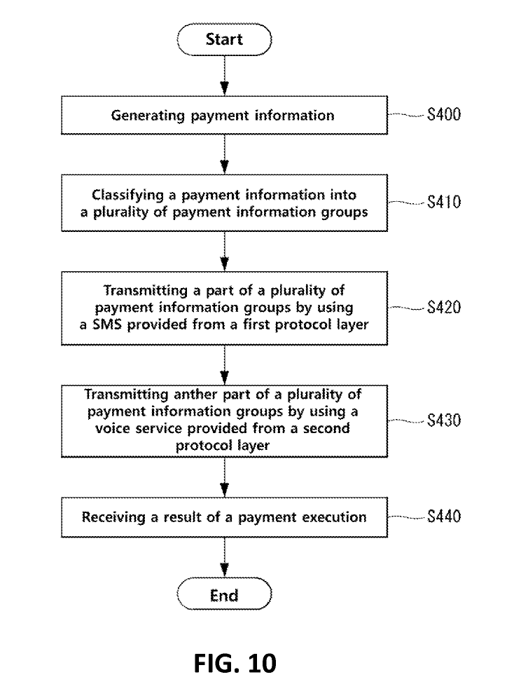

FIG. 10 is a flow chart illustrating an example of the payment method using the electronic device 100 according to the present invention. The payment method will be described below with reference to the accompanying drawings.

In a state where the network for a communication with the payment system 200 is formed based on a specific mobile communication protocol, a payment information is creased at the electronic device 100 (S400). The control unit 190 of the electronic device 100 divides the generated payment information into a plurality of payment information groups (S410). As described earlier, the control unit 190 may divide the payment information into a plurality of payment information groups based on a previously set security level.

Thereafter, the control unit 190 transmits a part of a plurality of the payment information groups to the payment system 200 by using a short message service (SMS) provided from the first protocol layer (S420). In addition, another part of a plurality of the payment information groups may be transmitted using a voice service provided from the second protocol layer (S430). Here, the security level of a part of the payment information groups may be higher than the security level of another part of the payment information groups. In addition, the security level of the short message service may be higher than the security level of the voice service.

Next, the electronic device 100 may receive a result of the payment execution from the payment system 200 (S440) and may display a result of the received payment execution on the display unit 150. So, the user may see the display unit 150 and may confirm a result of the payment execution.

In the above descriptions, referring to FIGS. 6 to 10, the examples wherein the electronic device 100 according to the present invention distributes the payment information through a plurality of the protocol layers defined by a specific communication protocol and transmits the same have been described. However, the scope of the present invention should not be limited by such descriptions. For example, the electronic device 100 may distribute the payment information through a plurality of the protocol layers defined by other communication protocols rather than the mobile communication protocol.

As described above, the payment method using an electronic device according to the present invention may be implemented in a form of the program which may be executed by various computer means and may be recorded into a computer-readable medium. The computer-readable medium may include a program command, a data file, a data structure, etc. which may be included in a single form or a form combined with each other. The program recorded in the medium may be a designed component specially designed for the present invention or may be a component which has been used by a person having ordinary skill in the computer and software field.

The example of the computer-readable recording medium may include a hard disk, a floppy disk, a magnetic medium such as a magnetic tape, an optical medium such a CD-ROM, a DVD, etc., a magneto-optical medium such as a floptical disk, a ROM, a RAM, a flash memory, and a hardware device which is specially configured to store and execute the program command. The program may include a machine language code programmed using a complier and a high level language code which may be executed by a computer by using an interpreter. The hardware device may be configured to operate as at least software module so as to perform the operations of the present invention or the reverse operation may be same.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. An electronic device, comprising:
a communication unit which is configured to perform a communication function with a payment system based on a specific communication protocol; and
a control unit which is configured to distribute the payment information to a plurality of protocol layers defined by the specific communication protocol and transmit to the payment system.

2. The device of claim 1, wherein the plurality of protocol layers comprise an encryption protocol layer which is configured to encrypt an allocated payment information and transmit to the payment system.

3. The device of claim 2, wherein the control unit controls for a payment information, the security level of which is higher than a predetermined security level, among the payment information to be transmitted to the payment system through the encryption protocol layer.

4. The device of claim 1, wherein the control unit transmits a part of the payment information to the payment system by using a short message service (SMS) provided from a first protocol layer, and transmits another part of the payment information to the payment system by using a packet data service provided from a second protocol layer.

5. The device of claim 4, wherein the security level of a part of the payment information is higher than the security level of another part of the payment information.

6. The device of claim 1, wherein the control unit transmits a part of the payment information to the payment system by using a short message service provided from the first protocol layer, and transmits another part of the payment information to the payment system by using a voice service provided from a third protocol layer.

7. The device of claim 6, wherein the security level of a part of the payment information is higher than the security level of another part of the payment information.

8. A payment method using an electronic device, comprising:
the step for forming a network for a communication with a payment system based on a specific communication protocol; and
the step for distributing a payment information to a plurality of protocol layers define by the specific communication protocol and transmitting to the payment system.

9. The method of claim 8, wherein the plurality of protocol layers comprise an encryption protocol layer for encrypting an allocated payment information and transmitting to the payment system.

10. The method of claim 8, wherein the step for transmitting the payment information to the payment system includes:
the step for transmitting a part of the payment information to the payment system by using a short message service provided from a first protocol layer; and
the step for transmitting another part of the payment information to the payment system by using a packet data service provided from a second protocol layer.

11. The method of claim 8, wherein the step for transmitting the payment information to the payment system includes:
the step for transmitting a part of the payment information to the payment system by using a short message service provided from the first protocol layer; and
the step for transmitting another part of the payment information to the payment system by using a voice service provided from a third protocol layer.

12. A recording medium having a stored code for executing a payment method using an electronic device of claim 7.

13. A recording medium having a stored code for executing a payment method using an electronic device of claim 8.

14. A recording medium having a stored code for executing a payment method using an electronic device of claim 9.

15. A recording medium having a stored code for executing a payment method using an electronic device of claim 10.

16. A recording medium having a stored code for executing a payment method using an electronic device of claim 11.
